(19) United States
(12) Patent Application Publication
(10) Pub. No.: US 2004/0060439 A1
(43) Pub. Date: Apr. 1, 2004

(54) Replaceable filter element assembly

(76) Inventor: Gerard G. Byrd, Martin City, MT (US)

Correspondence Address: Burkhart & Burkhart, Patent Attorneys, 940 Dakota Avenue, Whitefish, MT, 59937, US

(21) Appl. No.: 10/260,601

(22) Filed: Sep. 30, 2002

(51) Int. Cl. B01D 46/00

(52) U.S. Cl. 95/273; 55/498; 55/502

(57) ABSTRACT

A filter element assembly includes at least one housing. A filter medium is removably secured to the at least one housing. A securing mechanism is adapted and constructed to removably secure the filter medium to the at least one housing.

### FIELD OF THE INVENTION

The present invention relates generally to air filter elements, particularly to such elements adapted for use with internal-combustion powered heavy equipment used in adverse environments.

### BACKGROUND OF THE INVENTION

The desirability of filtering fluids circulating through internal combustion engines is well known. Among the fluids for which filters are commonly provided are oil, transmission fluid, fuel, and intake air. Such filters are subject to clogging and reduced performance over time, as they become clogged with filtrate materials. Filter elements are thus often made removable to facilitate cleaning or replacement of the filter element. Such replacement is of particular importance in high-stress environments, such as heavy equipment used outdoors.

Not surprisingly, a variety of solutions have arisen in attempting to accommodate this process. For example, U.S. Pat. No. 5,797,973 to Dudrey et al. is directed to constructions and methods for collecting particulate material from gas streams. In certain specifically described air filter arrangements, a first, rigid, filter construction is used in conjunction with a removable and replaceable depth media filter, to form filter media. The preferred arrangement is configured so that the removable and replaceable depth media filter can be removed and replaced, without disengaging the first filter construction from a filter assembly or housing, if desired. In this patent, a rigid internal filter element or cartridge includes first and second opposite end caps, with filter media extending therebetween. An inner liner can be fabricated from a porous metal liner or expanded metal liner, and an outer liner can be provided as scrim, i.e. a fibrous web of material.

The filter described in the Dudrey patent is typical of filters used in heavy equipment and off-road environments, in that the entire assembly, including the end caps, filter element, inner liner, and outer liner, is unitary. Consequently, when the filter is clogged, the entire assembly is removed. Cleaning of the filter can only be accomplished with the end caps and inner and outer liners in place, thus making it difficult to remove particles from the filter media. Alternatively, the entire assembly must discarded and replaced, resulting in the waste of potentially useful housing materials.

It can be seen from the foregoing that the need exists for simple, inexpensive air filter element assemblies that allow improved access to the filter media, particularly in elements adapted for use with internal-combustion powered heavy equipment used in adverse environments

### SUMMARY OF THE INVENTION

A filter element assembly includes at least one housing. A filter medium is removably secured to the at least one housing. A securing mechanism is adapted and constructed to removably secure the filter medium to the at least one housing.

### DESCRIPTION OF THE DRAWINGS

FIG. 1 is a schematic elevational view of a filter element assembly in accordance with the principles of the present invention.

FIG. 2 is a schematic exploded assembly view of the FIG. 1 filter element assembly.

FIG. 3 is a schematic perspective view of an end cap and core from the FIG. 1 assembly.

FIG. 4 is a schematic perspective view of an end cap from the FIG. 1 assembly.

FIG. 5 a schematic elevational view of an alternative embodiment of a filter element assembly in accordance with the principles of the present invention.

FIG. 6 a schematic elevational view of another alternative embodiment of a filter element assembly in accordance with the principles of the present invention.

### DETAILED DESCRIPTION OF THE INVENTION

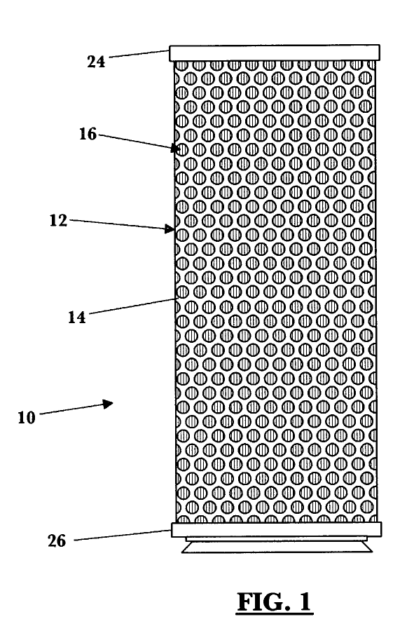

FIG. 1 illustrates a filter element assembly 10 in accordance with the principles of the present invention. The filter assembly 10 includes an outer housing 12, which can be fabricated from any suitable material, such as metal, durable plastic, or composite materials. It is contemplated that fabricating the outer housing 12 from sheet steel will provide acceptable levels of performance. The outer housing 12 is provided with a plurality of apertures 14, which permit the flow of fluid, here air, through the filter element assembly 10. The size and number of the apertures 14 are dependent upon the fluid flow requirements of the application in which the filter element assembly 10 is employed.

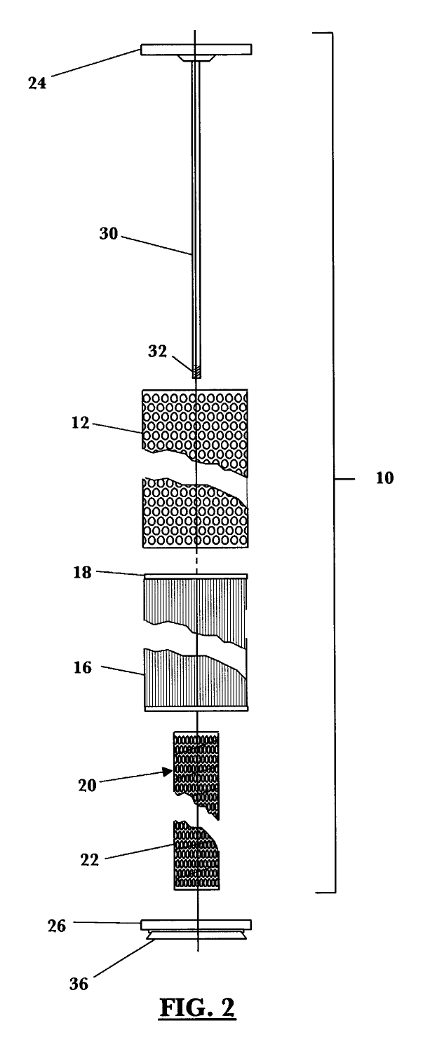

As seen in FIG. 2, an annular cylindrical filter medium 16 is removably inserted within the outer housing 12. The filter medium 16 can be of any suitable construction, such as chemically treated pleated paper. Cushion seals 18 can be provided at the top and bottom of the filter medium 16 for sealing and protection purposes.

An inner housing 20 is removably inserted into the filter medium 16, to provide rigidity and additional protection. The inner housing 20 is provided with fluid flow aperture 22, in the same manner and for the same purposes as apertures 14 in the outer housing 12.

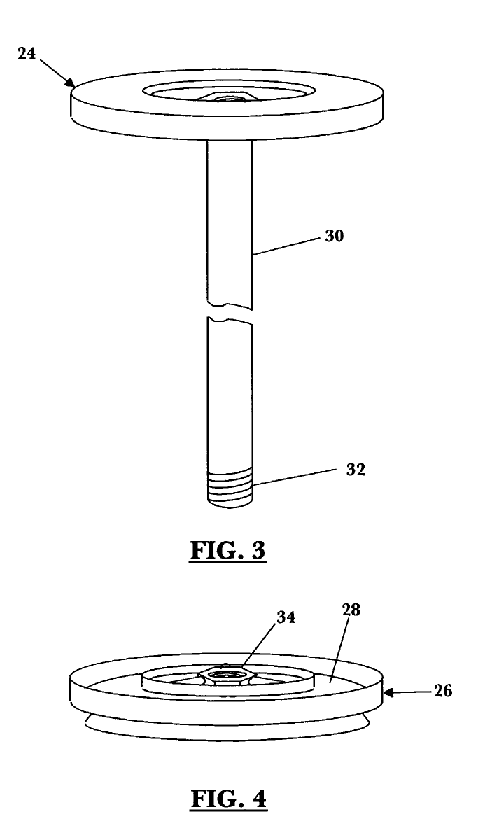

The outer housing 12, filter medium 16, and inner housing 20 are secured via a securing mechanism. In the embodiment illustrated in FIGS. 1-4, the securing mechanism includes a first end cap 24 and a second end cap 26. Each end cap 24, 26 is provided with an annular depression 28, which are adapted and constructed to receive the cushion seals 18 on the filter media 16, along with the respective ends of the assembled outer housing 12, filter medium 16, and inner housing 20. A core 30 removably secures the first end cap 24 to the second end cap 26. In the illustrated embodiment, the core 30 is fixedly secured to the first end cap 24 by known means. The core 30 is provided with threads 32 at an end opposite the end cap 24. The threads 32 are adapted to be secured to a threaded core receiver 34 on the second end cap 26. A seal 36 can be provided on the second end cap in a known manner. Of course, other suitable securing arrangements are contemplated within the scope of the present invention. For example, the outer housing can be fixed to one of the ends caps, with the other end cap being secured by a threaded or bayonet-type connection.

In operation, the filter medium 16 is inserted into the outer housing 12, and the inner housing 20 is inserted into the filter medium 16. The end caps 24, 26 are then placed over the respective ends of the outer housing 12, filter medium 16, and inner housing 20, the core 30 is tightened into the core receiver 34, and the assembly 10 is ready for installation. When the filter medium becomes clogged or damaged, the core is loosened, end caps and housings are removed, and the filter medium 16 can be cleaned, repaired, or replaced as needed.

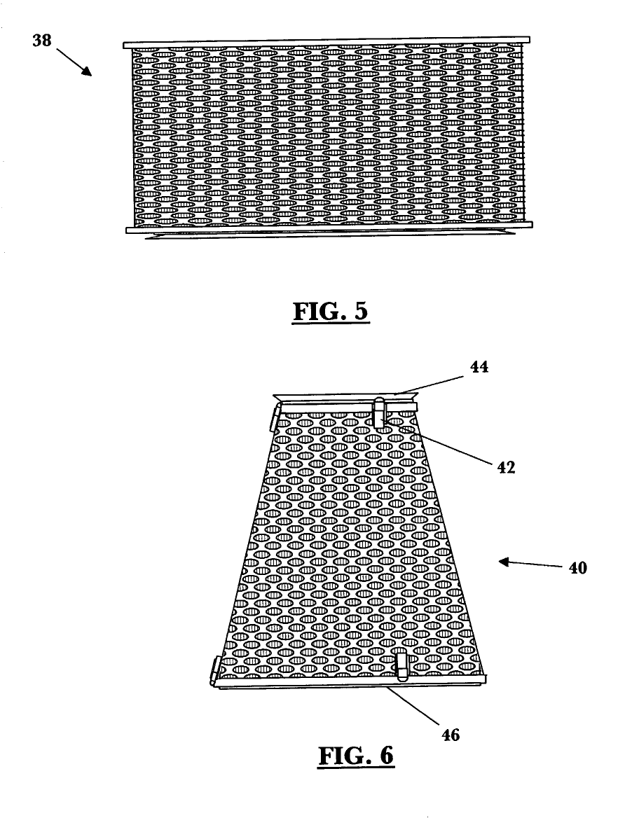

It will be appreciated by those of skill in the art that this arrangement can be varied within the context of the illustrated embodiments. For example, as shown in FIG. 5, a filter assembly 38 can be provided with a shorter aspect ration than that shown in the filter assembly of FIGS. 1-4.

Alternatively, other filter shapes can be accommodated, such as the frustoconical filter assembly 40 shown in FIG. 6. In this embodiment, the outer housing, inner housing, and end caps are secured by means of a plurality of latches 42. The narrow end 44 of the filter assembly 40 is closed, while the lower end 46 is open and annular. Consequently, there is no core as in the previously illustrated embodiments. One or more of the latches 42 can be located along an inner peripheral surface of the lower end 46 of the filter assembly 40.

Irrespective of the particular configuration, the replaceable filter media of the present invention can provide cost savings by reducing the amount of waste materials in filter replacement, and by allowing more efficient cleaning and repair of filter media. Although the present invention has been described with reference to specific embodiments, those of skill in the art will recognize that changes may be made thereto without departing from the scope and spirit of the invention as defined by the appended claims.

What is claimed is:

1. A filter element assembly comprising the following:
at least one housing;
a filter medium removably secured to the at least one housing; and
a securing mechanism adapted and constructed to removably secure the filter medium to the at least one housing.

2. A filter element assembly in accordance with claim 1, wherein the filter medium comprises an annular cylindrical filter medium.

3. A filter element assembly in accordance with claim 2, wherein the at least one housing comprises a pair of housings.

4. A filter element assembly in accordance with claim 3, wherein the pair of housings comprises the following:
an outer housing removably fitted over an outside surface of the filter medium; and
an inner housing removably inserted on an inner surface of the filter medium.

5. A filter element assembly in accordance with claim 1, wherein the securing mechanism comprises the following:
a first end cap adapted and constructed to receive a first end of the filter medium and at least one housing;
a second end cap adapted and constructed to receive a second, opposite end of the filter medium and at least one housing.

6. A filter element assembly in accordance with claim 5, wherein the securing mechanism further comprises a core removably securing the first end cap to the second end cap.

7. A filter element assembly in accordance with claim 6, wherein the core is fixedly secured to the first end cap, and removably secured to the second end cap.

8. A filter element assembly in accordance with claim 7, wherein the core is adapted and constructed to be threaded to the second end cap.

9. A filter element assembly in accordance with claim 1, further comprising a pair of cushion seals located at opposite ends of the filter medium.

10. A filter element assembly comprising the following:
an annular filter medium;
an apertured outer housing removably secured to an outer surface of the filter medium;
an apertured inner housing removably secured to an inner surface of the filter medium; and
a securing mechanism adapted and constructed to removably secure the filter medium to the inner and outer housings.

11. A filter element assembly in accordance with claim 10, wherein the filter medium comprises a pleated paper filter medium.

12. A filter element assembly in accordance with claim 11, wherein the securing mechanism comprises the following:
a first end cap adapted and constructed to receive a first end of the filter medium, outer housing, and inner housing;
a second end cap adapted and constructed to receive a second, opposite end of the filter medium, outer housing, and inner housing.

13. A filter element assembly in accordance with claim 12, wherein the securing mechanism further comprises a core removably securing the first end cap to the second end cap.

14. A filter element assembly in accordance with claim 13, wherein the core is fixedly secured to the first end cap, and removably secured to the second end cap.

15. A filter element assembly in accordance with claim 7, wherein the core is adapted and constructed to be threaded to the second end cap.

16. A filter element assembly in accordance with claim 10, further comprising a pair of cushion seals located at opposite ends of the filter medium.

17. A method of installing a filter element assembly in a vehicle, the method comprising the following steps:
providing an annular filter medium;
removably securing an apertured outer housing to an outer surface of the filter medium;
removably securing an apertured inner housing to an inner surface of the filter medium; and
removably securing the filter medium to the inner and outer housings via a securing mechanism.

18. A method in accordance with claim 17, wherein the step of removably securing the filter medium to the inner and outer housings comprises the following:
placing a first end cap over a first end of the filter medium, outer housing, and inner housing;
placing a second end cap over a second, opposite end of the filter medium, outer housing, and inner housing; and
securing the first end cap to the second end cap.

19. A method in accordance with claim 18, wherein the step of securing the first end cap to the second end cap comprises securing the first end cap to the second end cap via a core.

20. A method in accordance with claim 19, wherein the step of securing the first end cap to the second end cap comprises fixedly securing the core to the first end cap, and removably securing the core to the second end cap.
